(19) United States
(12) Patent Application Publication
(10) Pub. No.: US 2012/0272789 A1
(43) Pub. Date: Nov. 1, 2012

(54) Method and apparatus for producing nanoparticles

(75) Inventors: Ari Auvinen, Espoo (FI); Jorma Jokiniemi, Espoo (FI); Unto Tapper, Espoo (FI); Johanna Forsman, Espoo (FI); Johannes Roine, Espoo (FI)

(73) Assignee: TEKNOLOGIAN TUTKIMUSKESKUS VTT, Espoo (FI)

(21) Appl. No.: 13/508,812

(22) PCT Filed: Nov. 10, 2010
(86) PCT No.: PCT/FI2010/050906

§ 371 Date: Jul. 13, 2012

(30) Foreign Application Priority Data
Nov. 10, 2009 (FI) 20096162

(51) Int. Cl. B22F 9/02; H05B 6/10; B82Y 40/00

(52) U.S. Cl. 75/347; 75/367; 266/200; 977/900

(57) ABSTRACT

By means of the invention, nanoparticles, which can be pure metal, alloys of two or more metals, a mixture of agglomerates, or particles possessing a shell structure, are manufactured in a gas phase. Due to the low temperature of the gas exiting from the apparatus, metallic nanoparticles can also be mixed with temperature-sensitive materials, such as polymers. The method is economical and is suitable for industrial-scale production. A first embodiment of the invention is the manufacture of metallic nanoparticles for ink used in printed electronics.

The invention relates to a method, according to the preamble of Claim 1, for manufacturing nanoparticles.

The invention also relates to an apparatus, according to the preamble of Claim 12, for such a method.

The characteristic features of the method according to the invention are defined in the characterizing portion of Claim 1.

The characteristic features of the apparatus according to the invention are defined in the characterizing portion of Claim 12.

By means of the method and apparatus according to the invention, it is possible to manufacture nanoparticles, which can be of a pure metal, alloys of two or more metals, a mixture of agglomerates, or particles possessing a shell structure.

In the following, embodiments of the invention and their advantages are described with reference to the figures, in which

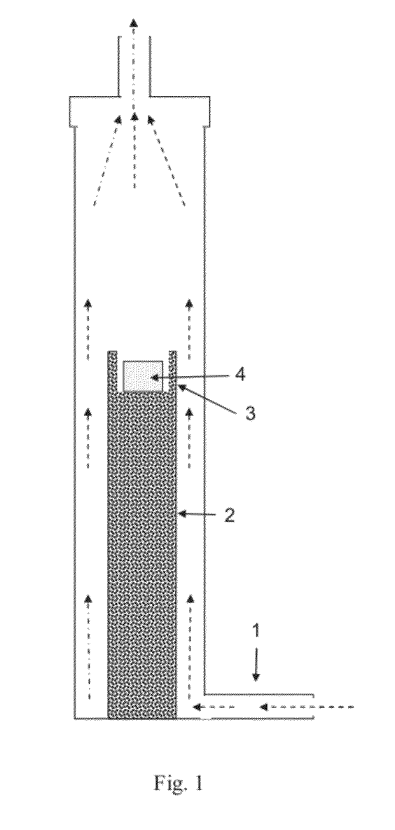

FIG. 1 presents an apparatus according to one embodiment;

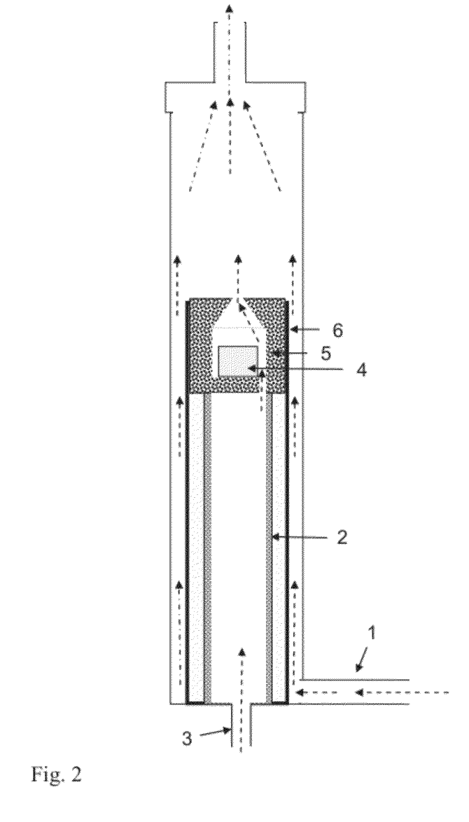

FIG. 2 presents an apparatus according to a second embodiment;

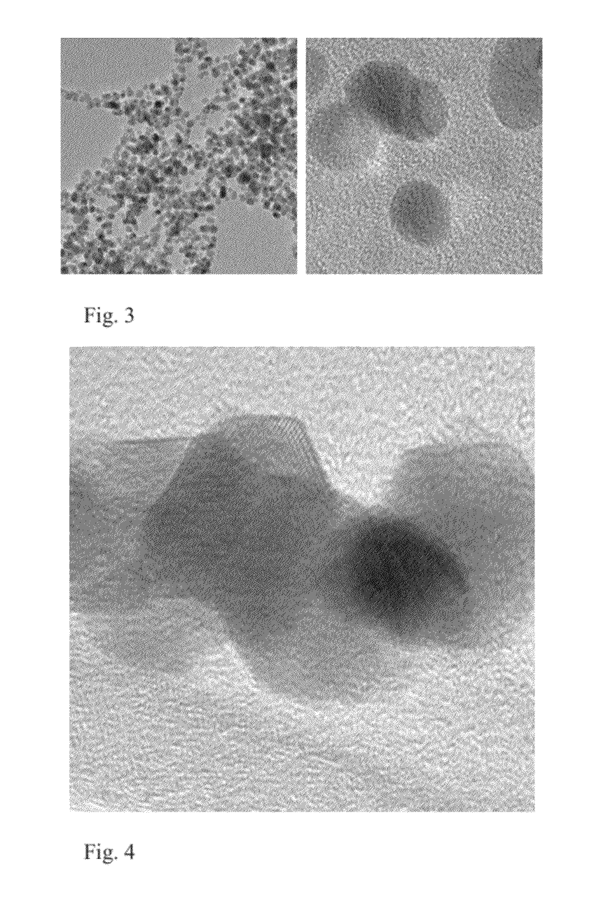

FIG. 3 presents nanoparticles manufactured according to one embodiment;

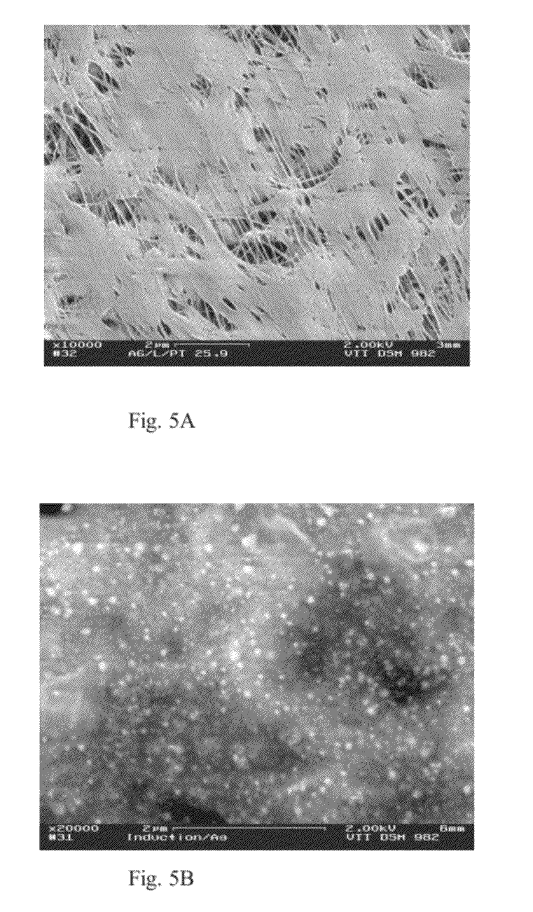

FIG. 4 presents nanoparticles manufactured according to a second embodiment;

FIG. 5 presents nanoparticles manufactured according to a third embodiment, on the surface of a filter material.

According to an embodiment, due to the low temperature of the process, metallic nanoparticles can also be mixed with temperature-sensitive materials, such as polymers. The method is economical and is suitable for production on an industrial scale. Such methods can be used, for example, in the following applications: the manufacture of metallic nanoparticles for ink used in printed electronics, as well as for an active material of optical components.

In a method according to one embodiment, alternating current is fed to a coil in induction heating, which induces a fluctuating magnetic field inside the coil. The fluctuating magnetic field in turn induces eddy currents in a metal piece. The resistance of the metal opposes the eddy currents and converts part of their energy into heat. The heating is efficient, as, in practice, the energy is transferred only to the metal. The efficiency of the heat production depends on the substance's resistance, its relative permeability, the size of the piece being heated, as well as the frequency of the alternating current.

FIGS. 1 and 2 show two alternative ways to construct an apparatus for producing nanoparticles using induction heating.

In the alternative shown in FIG. 1, an inert gas is fed from below to, for example, a glass tube 1, inside which is a high-temperature-resistant, for example ceramic, heat shield 3, set on top of a ceramic support structure 2. A vaporizing vessel 4, made from metal or graphite, and in which, in turn, the metals to be vaporized are placed, is set inside the heat shield. An induction coil outside the glass tube next to the vessel heats the vaporization vessel. The heat shield protects the coil from thermal radiation. In addition to the heat shield, the flow of cold inert gas travelling in the tube prevents the other parts of the apparatus from overheating.

In this application, when referring to the gas flow, the term cold refers to a temperature, which is substantially lower than the temperature of the metal vapour. On the temperature scale, cold can then mean, for example, temperatures that are less than 150° C., or, for example, temperatures in the range 0-100° C. One variation range that is highly suitable for practical applications is 15-35° C. Of course, it is also possible to use temperatures lower than those referred to and, in some applications, also temperatures that are higher.

For its part, the temperature of the vaporization vessel 4 can be, for example, 2300° C. and the temperature of the metal vapour still in the mixing stage can easily be more than 1500° C. Thus, the temperature difference between the metal vapour and the ‘cold’ gas flow is more than 1000° C. and often more than 1500° C.

In one embodiment, the apparatus for producing metallic nanoparticles operates in such a way that an inert gas is fed to a glass tube 1, inside which a heat shield 3 and vaporization vessel 4 are set on a ceramic support 2. The vaporization vessel is heated by induction.

In the alternative shown in FIG. 2, the inert gas is fed from below, for example, to a glass tube 1, as in alternative 1. Unlike in the above, the inert carrier-gas flow 3 is also fed into the ceramic support structure 2. The ceramic heat shield is replaced with a shield made from a double-layered material, which permits a temperature difference of more than 2000° C. on the outer surface of the vaporization vessel 4. The innermost part of the heat shield is of porous graphite felt 5, which has very low thermal conductivity and withstands high temperatures well. The outer layer 6 of the heat shield is manufactured from either quartz glass or a ceramic material. The task of the outer layer is to separate the cold gas flow and the carrier-gas flow from each other. Neither part of the heat shield may be electrically conductive.

In one embodiment, the apparatus of FIG. 2 is used for the production of metallic nanoparticles, in such a way that an inert gas is fed to the glass tube 1. A gas flow, which carries with it the vaporized metal from the vessel 4, is also fed into the ceramic support 2. The inner part 5 of the two-layer heat shield is of a material that conducts heat extremely poorly while the outer part 6 prevents the flows from mixing too early. The evaporation vessel is heated by induction, as in the embodiment of FIG. 1.

The upper part of the two-layer heat shield also acts as a flow baffle, which effectively mixes the carrier gas and the cold flow with each other. The shape of the piece is optimized by 3D flow measurement and CFD computation. On the inside, the heat shield is shaped in such a way that the radiant heat of the evaporation vessel heats its inner surface, thus reducing the loss of metallic vapour to the apparatus. In addition, by means of the shaping of the internal parts of the heat shield, the carrier-gas flow can be effectively guided to the evaporation vessel.

Thanks to the double-layer heat shield, the temperature of the oven can be raised considerably, compared to the embodiment of FIG. 1, in which case the mass yield of particles will increase correspondingly. The higher temperature will also permit a wider range of metals to be produced. In addition, in the embodiment of FIG. 2, the mass yield of particles can be regulated by altering the carrier-gas flow.

In both alternatives, the vaporized metal forms nanoparticles when it mixes with the turbulent cold gas flow. The speed of the mixing and the great temperature difference restrict the growth of the particles. In addition, all the particles formed will have a nearly identical temperature history and delay time in the apparatus. Thanks to the thermal radiation, the temperature on the walls of the apparatus is higher than the temperature of the gas. For this reason, thermophoresis drives the particles away from the wall, thus preventing losses to the apparatus. Because the gas fed to the apparatus is inert, the particles do not oxidize. In practice, impurities come only from the metals used as the basic material, so that the purity of the particles corresponds to the purity of particles produced by laser ablation.

The method's greatest advantage is the low temperature of the gas, which permits the collection of the particles produced, for example, in a conventional filter immediately after the nucleation zone, without excessive dilution and the associated cooling. The nanoparticles thus produced are of very even quality. The manner of production is also suitable for the production of nanoparticles consisting of metal alloys. These excellent results can be seen in FIGS. 3 and 4.

FIG. 3 shows images of produced silver particles, taken with a transmission electron microscope (TEM). A typical particle size is about 10-20 nm, depending on the number concentration of the particles.

FIG. 4 shows a TEM image of produced Sn—Bi alloy particles.

The low temperature permits the particles to be coated in a gas phase with heat-sensitive materials. In tests, silver nanoparticles have been coated, for example, with L-leucine and PAA. FIG. 5A shows coated particles collected on a filter. For its part, FIG. 5B shows silver particles, which have remained on the surface of a filter, when L-leucine has been evaporated from it at a temperature of 150° C.

FIG. 5A is an SEM image of a filter, on which silver particles coated with a thermally sensitive a-amino acid (L-leucine) have been collected. FIG. 5B is an SEM image of silver particles in a filter. The L-leucine is removed by heating the filter 3 of FIG. 5A to a temperature of 150° C. for 3 hours.

The coating prevents the particles' oxidation as well as growth as a result of agglomeration. Thus, the coated particles are easy to handle and store. In addition, coating can be used to facilitate, for example, the dispersion of the particles in liquids or a solid medium.

The apparatus has a low energy requirement and the gas flows are very reasonable. The production of particles takes place at atmospheric pressure, so that the expensive vacuum technology, typical in the manufacture of nanoparticles, need not be used. In the method, there is also no need for expensive special chemicals as source materials. In addition, induction heating is a technique that has been traditionally very widely used in the engineering industry. Thus, the manufacturing method can be quite easily scaled up to an industrial scale using already existing technology.

With the aid of the embodiments, it is thus possible to manufacture, in the first stage, metallic nanoparticles for inks for printed electronics. Tin, bismuth, silver, copper, and aluminium, for example, have been manufactured for this purpose. Alloys of the aforementioned metals, with a particularly low melting point, have also been produced using the technology.

TiO2 particles, coated with nanosilver or nanocopper, for antibacterial filters or surfaces, can be manufactured using the method.

The manufacturing method also works in the manufacture of aluminium nanoparticles doped with magnesium. This material can be used, for instance, in the manufacture of OLED displays.

Other possible applications are the production of nanomaterials for the manufacture of printed sensors, the combination of metallic nanoparticles with electrically conductive polymers, as well as the manufacture of nanocomposites for energy storage and optical components.

Thus, in one embodiment, the method is implemented in order to manufacture nanoparticles containing at least one metal, in which method at least one metal is vaporized and the vapour mixed with a gas flow, the temperature of which is lower than the temperature of the vapour.

According to one embodiment, the gas flow consists of an inert gas or inert gases. The temperature of the gas flow can be less than 150° C., for example in the range 0-100° C., such as in the range 15-35° C. The temperature difference between the temperature of the gas flow and the temperature of the metal vapour is at least 1000° C., for example more than 1500° C.

In the embodiments, the gas flow is preferably turbulent when mixing the vapour with the gas flow.

In one embodiment, vaporization is performed by induction heating with the aid of a coil and an electrically conductive vaporization vessel, and, in the induction heating, an alternating current is fed to the coil, which induces a fluctuating magnetic field inside the coil. The fluctuating magnetic field in turn induces eddy currents in the conductive vaporization vessel and the resistance of the vessel resists the eddy currents, when the energy is converted into heat. The heating is thus efficient, as in practice the energy transfers only to the vaporization vessel, so that the efficiency of the heat production depends on the vessel's resistance, its relative permeability, the size and shape of the vessel, and the frequency of the alternating current.

In the embodiments, induction heating can be used to create a steep temperature gradient.

In one embodiment, an inert gas is fed from below to, for example, a glass tube, in which there is a, for example, ceramic heat shield that withstands high temperatures, set on top of a ceramic support structure. Inside the heat shield is placed a vaporization vessel, in which for their part the metals to be vaporized are placed, made of a metal that withstands high temperatures, or graphite. Outside the glass tube, next to the vessel, an induction coil heats the vaporization vessel while the heat shield protects the coil from thermal radiation at the same time as the flow of cold inert gas travelling in the tube prevents the other parts of the apparatus from overheating. Thus, the thermal radiation heats the surface of the apparatus to be hotter than the cold gas flow, so that the losses to the apparatus are reduced due the effect of thermophoresis.

In one embodiment, when using a high temperature, the ceramic heat shield is replaced with a shield manufactured from a double-layered material, which permits a temperature difference of more than 2000° C. on the outer surface of the vaporization vessel.

According to one embodiment, the inert gas is fed both inside the heat shield, where it becomes hotter, and to outside the heat shield. The inner part of the heat shield can then be, for example, of porous graphite felt, the thermal conductivity of which is extremely low and which withstands very high temperatures. In addition, the shaping of the inner part of the heat shield can be used to promote the heating of its surface from the effect of thermal radiation and to guide the gas flow to the vaporization vessel, when the yield can be regulated by varying the velocity of the gas. The outer layer of the heat shield can be manufactured from a material impermeable to gas, so that the hot and cold gas flows will not mix too early.

In the embodiments, it is possible to achieve the very rapid cooling of the metal vapour when is mixed turbulently with the cold gas flow. The nanoparticles formed then solidify before they collide with each other and do not grow in size as a result of coagulation.

In one embodiment, the apparatus operates at normal atmospheric pressure, which not only reduces the pumping power required but also increases the speed of the heat transfer from the particles to the gas.

The gas flow out of the apparatus can also be kept cool, thus permitting both the mixing of the particles and also their coating with heat-sensitive materials prior to the collection of the particles.

In one embodiment, an apparatus is implemented for manufacturing nanoparticles containing at least one metal, which apparatus comprises a vaporization vessel 4 for creating a metal vapour from at least one metal and a heat shield 3 surrounding the vaporization vessel 4, in order to permit a temperature difference between the vaporization vessel 4 and the environment. In the heat shield 3, there is also at least one opening, through which the metal vapour can flow into the environment. In addition, the apparatus comprises a first flow path for leading a first gas flow past the heat shield 3 into contact with the metal vapour that has flowed into the environment, in order to mix the metal vapour with the first gas flow. This first gas flow is thus the ‘cold’ gas flow described above.

The apparatus can also comprise an induction-heating device for heating the vaporization vessel 4.

Further, in one embodiment, the apparatus comprises a mixing chamber, into which the first gas flow bypassing the heat shield 3 and the metal vapour flowing from at least one opening in the heat shield 3 are led for mixing. In FIGS. 1 and 2, the mixing chamber is located in the upper part of the apparatus.

Further, in one embodiment, the apparatus comprises a second flow path, for leading a second gas flow into the heat shield 3 surrounding the vaporization vessel 4 and past the vaporization vessel 4 and then out of at least one openings in the heat shield 3. One such embodiment is shown in FIG. 2.

The embodiments of the invention can also vary widely within the scope of the Claims.

1. A method for manufacturing nanoparticles containing at least one metal comprising vaporizing at least one metal and mixing the vapour with a gas flow, the temperature of which is lower than the temperature of the vapour.

2. A method according to claim 1, in which the gas flow consists of an inert gas or inert gases.

3. A method according to claim 1, in which the temperature of the gas flow is less than 150° C.

4. A method according to claim 1, in which the temperature difference between the temperature of the gas flow and the temperature of the metal vapour is at least 1000° C.

5. A method according to claim 1, in which the gas flow is turbulent when the vapour mixes with the gas flow.

6. A method according to claim 4, wherein
vaporization is performed by means of induction heating, with the aid of a coil and an electrically conductive vaporization vessel,
in the induction heating, an alternating current is fed to the coil, which induces a fluctuating magnetic field inside the coil,
for its part, the fluctuating magnetic field induces eddy currents in the vaporization vessel, the resistance of the vessel resists the eddy currents and converts part of their energy into heat,
the heating is efficient, as in practice energy is transferred only to the vaporization vessel, so that the efficiency of the heat production depends on the vessel's resistance, its relative permeability, the size and shape of the vessel, and the frequency of the alternating current.

7. A method according to claim 6, in which induction heating is used to create a steep temperature gradient.

8. A method according to claim 6, wherein
the inert gas is fed from underneath, for example, to a glass tube, in which there is a, for example, ceramic high-temperature-resistant heat shield set on top of a ceramic support structure,
a vaporization vessel, in which in turn the metals to be vaporized are placed, manufactured of a high-temperature-resistance metal or graphite, is set inside the heat shield,
an induction coil, outside the glass tube at the location of the vessel, heats the vaporization vessel while the heat shield protects the coil, at the same time as the cold flow of the inert gas prevents the other parts of the apparatus from overheating, and
the radiant heat heats the surface of the apparatus to be hotter than the cold gas flow, when the losses to the apparatus decrease due to the effect of thermophoresis.

9. A method according to claim 6, in which
when using a high temperature, the ceramic heat shield is replaced with a shield manufactured from a double-layered material, which permits a temperature difference of more than 2000° on the outer surface of the vaporization vessel,
the inert gas is fed both to the inside of the heat shield, where it heats up, and to the outside of the heat shield,
the inner part of the heat shield is of porous graphite felt, the thermal conductivity of which is extremely low and which withstands very high temperatures well,
the shaping of the inner part of the heat shield promotes its surface heating from the effect of radiant heat as well as guides the gas flow to the vaporization vessel, in which case the yield can be regulated by altering the velocity of the gas,
the outer layer of the heat shield is manufactured from a material impermeable to gas, so that the hot and cold gas flows will not mix too early.

10. A method according to claim 6, in which
the metal vapour cools very rapidly when it mixes turbulently with the cold gas flow,
the nanoparticles then formed solidify before they collide with each other and do not grow as a result of coagulation,
the operation of the apparatus at atmospheric pressure not only reduces the pumping power required but also increases the speed of heat transfer from the particles to the gas.

11. A method according to claim 6, in which the gas flow exiting from the apparatus is cool, thus permitting both the mixing of the particles and also their coating with heat-sensitive materials prior to the collection of the particles.

12. An apparatus for manufacturing nanoparticles containing at least one metal, comprising;
a vaporization vessel for creating a metal vapour from at least one metal,
a heat shield surrounding the vaporization vessel, in order to permit a temperature difference between the vaporization vessel and the environment, the heat shield having at least one opening through which the metal vapour can flow to the environment, and
a first flow path for leading a first gas flow past the heat shield into contact with the metal vapour that has flowed into the environment in order to mix the metal vapour with the first gas flow.

13. An apparatus according to claim 12, which further comprises an induction-heating device for heating the vaporization vessel.

14. An apparatus according to claim 12, which further comprises a mixing chamber, into which the first gas flow bypassing the heat shield and the metal vapour flowing from the at least one opening in the heat shield is lead for mixing.

15. An apparatus according to claim 14, which comprises a second flow path for leading a second gas flow into the heat shield surrounding the vaporization vessel, past the vaporization vessel and then out through the at least one opening in the heat shield.

16. An apparatus according to claim 14, wherein the mixing chamber is configured to create turbulence in the first gas flow such that the first gas flow is turbulent when the metal vapour mixes with the first gas flow.

17. An apparatus according to claim 16, wherein the mixing chamber is a non-vacuum chamber configured to be operated at substantially normal atmospheric pressure.

18. A method according to claim 4, wherein the method is performed at substantially normal atmospheric pressure.

19. A method according to claim 4, in which the temperature difference between the temperature of the gas flow and the temperature of the metal vapour is more than 1500° C.

20. A method for manufacturing nanoparticles containing at least one metal, the method comprising:
vaporizing at least one metal to form metal vapour having a first temperature, and
mixing the metal vapour with a turbulent gas flow at substantially normal atmospheric pressure, the turbulent gas flow having a second temperature, wherein the second temperature is at least 1 000° C. lower than the first temperature.
